(19) United States
(12) Patent Application Publication
(10) Pub. No.: US 2006/0101116 A1
(43) Pub. Date: May 11, 2006

(54) Multifunctional telephone, walkie talkie, instant messenger, video-phone computer, based on WiFi (Wireless Fidelity) and WiMax technology, for establishing global wireless communication, network and video conferencing via the internet

(76) Inventors: Danny Rittman, Durham, NC (US); Moshe Schnapp, West Hollywood, CA (US)

Correspondence Address: DANNY RITTMAN, 5101 Starcross Lane, Durham, NC, 27713, US

(21) Appl. No.: 10/974,989

(22) Filed: Oct. 28, 2004

(51) Int. Cl. G06F 15/16

(52) U.S. Cl. 709/204

(57) ABSTRACT

This paper describes a method and a wireless telephone computer system, based on WiFi (1) and WiMax (2) technology for establishing global communication via the internet. This invention is consist of a Walkie-Talkie, a high speed multifunction wireless computer/instant messenger communicator, Personal Digital Assistant (PDA) and a telephone system, deploying multiple wireless networks and protocols such as Voice Over IP, GPRS, WAP, Bluetooth, PCS, I-Mode, comprising a high speed Intel Pentium 4 Mobile™ or compatible Processor, to formulate an internet gateway system and network bridge for establishing instant low cost, real time global communications to the Public Switched Telephone Network via the internet. A PUSH-TO-TALK button instantly initiates global bisynchronous communications, or videoconferencing sessions. Fax, VideoMail, and unified messaging services are immediately available. The invention provides uniformed global wireless communications, eliminates traditional long distance costs, and operates anywhere where WiFi (1) and/or WiMax (2) service is provided. The invention covers static and portable wireless based computer telephone, walkie-talkie, instant messenger, PDA, video-phone system based on WiFi (1) and WiMax (2) technology. This invention works as a telephone and personal communicator where WiFi and WiMax service is provided via HotSpot (3). The system works as a typical cellular phone providing low cost or FREE local and long distance calls via the internet. The system takes advantage of the wireless WiFi and WiMax technology to automatically connect to the internet and perform phone calls, Fax, Email, Web Surfing, Instant messaging and data networking. With the increased popularity of WiFi and WiMax technology, users can enjoy FREE and/or low cost phone call and personal communication services where a HotSpot coverage is provided.

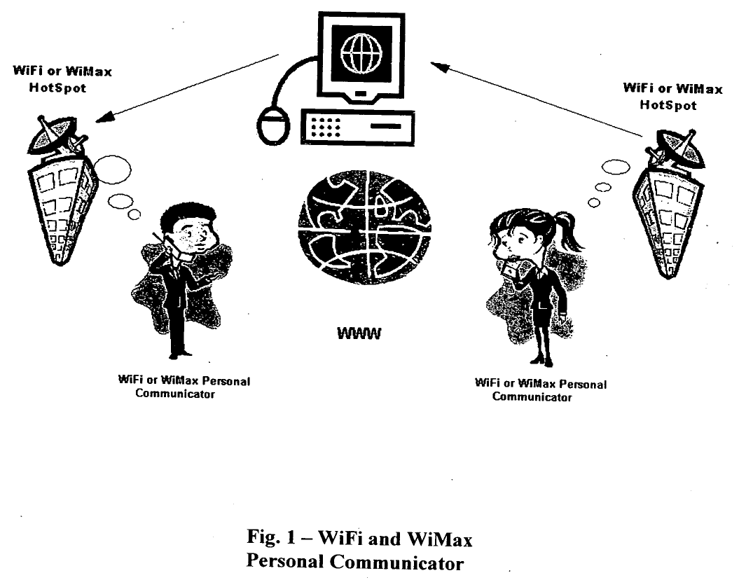

### BACKGROUND OF THE INVENTION

1. Field of the Invention

The “WiFi and WiMax based telephone, walkie-talkie, instant messenger and videoconferencing” invention disclosed herein relates to the field of computer science and telecommunications. It is specifically founded upon wireless computer technology and digital communications and is directly related to local/wide area networks and internet protocol (IP) telephony communications. This invention presents a multi-functional, high speed, hand held wireless communicator and computing device that is based on WiFi and WiMax technology and capable of automatically connecting to any data network such as the internet. The invention requires a WiFi and WiMax HotSpot coverage in order to connect to data network and the internet. Using the WiFi and WiMax technology the invention can be used as a telephone, instant messenger, walkie-talkie, and video-phone and computing device.

2. Background of the Invention

A specialized high speed device, resilient network, and internet based web server are presented which provides voice and text based INSTANT MESSENGER communications services, and enhanced Quality of Service (QOS) over a wireless network utilizing Voice Over Internet Protocol technology.

Group Packet Radio Service Protocol (GPRS), Wireless Access Protocol (WAP), Bluetooth specification, Global System for Mobile Communications (GSM), Internet communications, Japan's I-mode service, and a variety of other wireless communications protocols are deployed in the invention which provides communications between the internet and the public switched telephone network. The resulting invention and network connects users of the internet to users of wireless networks, the Public Switch Telephone Network and can be used worldwide on any continent and from anywhere in the world.

The WiFi and WiMax wireless device and high speed network presented provides a robust and enhanced architecture for delivering real time voice, video, fax, and integrated data intercommunications to internet users and customers of the Public Switched Telephone Network (PSTN) at more efficient and cost effective means.

Along with the INSTANT MESSENGER system, a high speed Mobile Intel® Pentium® 4 Processor chip, and other enhanced network communications is also used in order to over come many of the communication problems with Quality Of Service (QoS) such as delay, accumulation delay, echo, processing delay, and network delay problems, associated with Voice Over Internet Protocol applications.

Enhanced Voice & Video Quality & Open Standards

The invention suggests better system then the normal cellular and satellite telephone technology by providing enhanced capabilities, WiFi and WiMax technology based, like internet voice, video quality, open standards, and network methods which set a precedent for “a world-wide standard” for wireless intercommunication using the internet, wireless telephone networks, and the Public Switched Telephone Network. The invention comprised of both the wireless device and high speed resilient, robust network system and wireless telephone networks, delivers an Internet ecosystem which thrives on opens standards, and encourages the development and interoperability of multi-vendor, multi-product solutions that are generally accepted by both the telephone and computing industry.

The WiFi and WiMax technology based wireless invention provides customers with instant and convenient “push button” program functionality providing efficient unified messaging. The transmission of voice, data, and video communications in real-time or offline communications via the internet, to the Public Switched Telephone Network (PSTN) and from anywhere in the world is accomplished.

The invention also deploys a special PUSH-TO-TALK button which when depressed, initiates instant global communications between two or more devices connected to the internet a wireless network, or the public switched telephone network allowing the invention to instantly communicate with computer based internet users or any telephone, fax machine, or computer connected to the world wide telephone network.

The computer invention converts into a Personal Digital Assistant (PDA) and provides unlimited mobile applications and telecommunications on a world-wide basis and also deploys a self-charging solar battery system and other standard power systems to keep the system up and running when needed.

The invention adopts all the interfacing standards adopted by the telecommunication industry such as Telephony Applications Programmable Interface (TAPI) and the Java Telephony Application Programmable Interface (JTAPI).

The elimination and need for costly PBX systems is possible by deploying a high speed microprocessor enhanced high speed Voice Over Internet Protocol network. The Private Branch Exchange (PBX) system can now be completely eliminated and replaced with efficient wireless IP telephony that is able to provide call-control functionality over a converged data network. When used in conjunction with IP telephone sets or software telephone applications will also provide services which exceed that of a normal PBX system and will continue to provide PBX functionality in a distributed and scalable fashion.

A super speed Mobile Intel® Pentium® Processor, or compatible processor, is introduced to the design in conjunction with an operating system, real time Java™ virtual environment, and provides for new and innovative applications such as unified messaging including instant fax, voice mail, video email, video conferencing, and email applications that can be launched at the press of a button.

The invention provides for end-to-end IP wireless telephony that provides a high quality-of-service (QoS) and enabled IP infrastructure that can be used worldwide on any data network including the internet. The invention uses WiFi and WiMax technology to connect to telephone technology with highly optimized data networks such as Net2phone networks, and Cisco™ AVVID (Architecture for Voice and Integrated Data system). The system embraces the concept of a local or wide area network in order for customers to instantly contact each other at minimal cost, from anywhere in the world, and without the high cost normally associated in long distance or international communications.

Advanced instant messaging and communications software system automatically connects to the internet at high speeds, and stays connected allowing customers to “stay online” in order to be in contact with the network and each other twenty four hours a day.

Customers and users of the system can make instant wireless contact initiate video conferences, chat sessions, and voice chat sessions with other internet users such as Yahoo™, America Online™ and other internet users. This feature adds a powerful functionality, and features not obvious in the prior art.

The powerful use of global WiFi and WiMax technology, internet technology, and the ability to communicate directly through HotSpots puts the invention in a totally separate class from the normal cellular or satellite telephones generally offered by the telephony or computing industry. Since the WiFi and WiMax transmitter is constantly connected user is virtually constantly connected to the internet and can make phone calls, video conferencing, instant messaging and use the walkie talkie feature to directly communicate with other users.

The nature and technical field of this invention provides for unlimited mobile computing power and computer applications with the implementation of the Java™ based environment and a Personal Digital Assistant that deploys either of two of the most widely used handheld operating systems: the Palm VII™ or the Windows Pocket PC 2004 operating systems™.

Finally, full access and interconnectivity can still be maintained to a wireless network, and the Public Switched Telephone Network allowing users with normal telephones, cellular telephones, satellite telephones, computers or other compatible devices to intercommunicate with the invention. The invention in essence provides a world wide wireless telecommunications system, that can be used anywhere in the world where WiFi and WiMax technology is installed.

With the enormous growth of the WiFi and the WiMax technology around the world, using the invention in a cellular phone shaped case, creates a cheap and affordable new style communication device.

### SUMMARY OF THE INVENTION

Objects and Advantages

Accordingly several objects, advantages, and new uses of the present invention exists that provide low cost enhanced Quality Of Service (QoS), and instant voice messaging over an internet protocol (IP) enabled Voice Over Internet Protocol Services (VoIP) network or internet-work. The ability to communicate through both the internet and a telephone network using WiFi and WiMax technology creates a new dimension in world-wide personal communication.

On the go mobile computing power, push button unified messaging, and other services such as digital Voice Mail, Video Mail, real time video conferencing, and the transmission of data between two or more interconnected devices on a world wide basis (over any type voice or data network) independently of service providers are central to the objectives of the invention.

The ability of the battery solar charging system will guarantee power even in remote places on earth where electrical outlet or power sources are not available.

Many other objects and advantages of the present invention exists and are described below as follows:

a. An object of the invention is to provide a means of high quality voice and data communications between Internet users and customers of the worldwide Public Switched Telephone Network at minimal cost using the Internet or any data network.

b. Another objective of the invention is to provided customers with a multifunction hand held computer and alternate various means of wireless instant messaging and telecommunications enabling digital communications from or to anywhere in the world without distance limitation or the normal high cost associated with the use of long distance or international telecommunications normally charged with the use of the Public Switched Telephone Network (PSTN).

c. Another objective of the invention is to provide integration of internet voice and data services with services to the Public Switched Telephone Network which would open the door to a new generation of digital and cost effective communication services that combine Web-based data with voice and data calls.

d. Another objective of the invention is to provide wireless high Quality Of Service (QoS) via the internet or data network and a central gateway interface where end-users on the internet are able to instantly communicate through various means with other users on the internet or the public switched telephone network.

e. Another objective of the invention is to provide material cost reduction to companies or individuals involved in long distance telephone, facsimile, and data communications, which is extremely important to most companies and individuals particularly to those with international market and contacts.

f. Another objective of the invention is to provide secured private telephone conversation through VoIP communications and to prevent the unauthorized monitoring of telephone calls by governments or other unauthorized persons not authorized to participate in telephone conversations.

g. Another object of the invention is to provide more simplification of technology by deploying integrated voice/data networks that will reduce total cost and equipment requirements.

h. A further objective of the invention is to provide consolidation or the ability to eliminate points of failure, consolidate accounting systems and combine operations on one diverse platform providing for enhanced communications and efficiency.

i. Still yet another objective of the invention is to provide for Advanced Computer applications and support for multimedia and multi-service VoIP applications, and software advantages which today's Private Branch Exchange (PBX) or public telephone system simply cannot compete with.

j. A further objective of the invention is to provide a world wide compatibility device and method which can connect to Japan's I-mode service allowing any user of the internet to communicate with devices that use the I-mode service in Japan.

k. Still yet another objective of the invention is to provide Wireless Access Protocol (WAP) compatible services, and General Packet Radio Services (GPRS) technology which maintain an “always on” connection between users, wireless devices, and other devices connected directly or indirectly to the internet via other data networks which will allows users of other cell phones or devices to communicate easily regardless of where the call is originated from.

l. Another objective of the invention is to integrate communications between the internet, users of the network, and users of the Public Switched Telephone Network (PSTN) with the use of a high speed Voice Over Internet Protocol enabled internet server, software, and wireless devices.

m. A further objective of this invention is to provide an open systems architecture so that future applications may be easily designed to take advantage of bandwidth and services offered by larger ip network providers such as Net2phone, or any third party IP service providers offering OEM or third party VoIP development opportunities.

n. Another primary objective of this invention is to provide a new world standard for digital communications using WiFi and WiMax technology. This technology may be easily used where HotSpot is installed. The anticipation is that by the year 2006 every public institute, airports, trains, commercial airlines, restaurants, and more will be equipped with WiFi and/or WiMax technology.

o. Still yet another objective of the invention is to provide a bluetooth wireless foundation for the invention and interconnectivity and integration of computing equipment such as laptops, desktop computers, printers, and scanners, which have the need to interface and exchange data and information between the invention and other computing equipment for increased customer productivity.

s. A further object of the invention is to provide advanced computing applications and on-the-go mobile computing services to customers that use hand held computers by providing a built-in Personal Digital Assistant that uses the Palm OS™ Operating System or the Windows Pocket PC™ 2004 operating system for hand held computers.

t. Still yet another object of this invention is to provide a means for sharing data and information between computing devices and the invention which will allow customers to synchronize data between a personal computer and the wireless invention.

u. A further object of the invention is to provide functionality of a hand-held wireless computer terminal which can access any network or computer in the world using the public switched telephone network or the internet.

v. Another object of this invention is to provide a real time functional digital web camera that will allow uses to create, and store, digital images and real-time Mpeg movies that can be shared or transferred to any email address or computer attached to the backbone of the internet.

w. Still yet another objective of the invention is to provide a central network or internet based web server that provides a wide spectrum of services including robust Quality of Services (QoS) and a host of consumer services, including e-commerce, m-commerce, which are available to registered users of the network.

x. Another object of the invention is to provide a means of internal MPEG-3 format that provides a method of compressing digital animation and Television Signals that reduce their size but still retain their high quality.

y. Another object of the invention is to lower cost by providing an alternate means of communications using worldwide connectivity between devices, users of the internet, and the public telecommunications system and by deploying an impressive array of Voice Over Internet Protocol (VoIP) protocols and QOS standards of communications which overcome the delays normally encountered with Voice Over Internet Protocol applications.

z. Still yet another object of the invention is to provide a means of transmitting crystal clear compressed digital voice and/or video communications on a world wide basis without distance limitation or reliance upon any telecommunications vendor.

aa. Still yet another objective of the invention is to provide customers with a means of accessing the internet and surfing the world wide web through one convenient mobile wireless device from anywhere in the world regardless of location.

bb. A further object of the invention is to provide a means to limit, or otherwise eliminate long distance fraudulent charges imposed by telecommunications or private telecommunications carriers.

cc. Another object of the invention is to provide cost effective fax transmission, and high quality video conferencing to any other compatible wireless unit, computer, or fax machine in the world.

dd. A further object of the invention is to provide extended battery life, enhanced multimedia applications, performance, and increased bandwidth with the use of a high speed built-in Intel® Mobile Pentium™ 4 microprocessor or compatible processor for enhanced communications.

ee. Another object of the invention is to provide a built-in operating system that control processes, functions, and methods of the invention to enable users to easily and effectively use applications inherent to the design of the invention.

ff. Another object of the invention is to provide an Artificial Intelligent interface which allows voice commands to be executed, and to enable customers to compose email or text messages from human speech that can be easily transmitted via email or by instant messaging services.

gg. Still yet another object of the invention is to provide mass data base storage for information storage and retrieval and storage for multimedia rich content data files which are generally unavailable to normal cellular or satellite telephones.

hh. Another object of the invention is to provide built-in Java® based virtual machine functionality and an environment for executing custom java applications and software programs that can be run and executed using the Java® specification.

ii. Another main objective of the invention is to provide instant “push button” convenience services that include but not limited to, SEND VOICE MAIL, SEND FAX MESSAGE, SEND EMAIL, SEND VIDEO MAIL, MESSAGE MEMO which services are easily operated and activated with the simple press of button.

jj. Another object of the invention is to provide an Open Standards Based Architecture and adoptions of standards so that gateways, applications, and clients produced may integrate and operate seamlessly with third party products.

kk. Another objective of the invention is to provide compatibility with standards adopted by the telecommunications industry including the Telephony Application Programmable Interface (TAPI) and the Java Telephony Application Programmable interface (JTAPI) which are used to communicate between applications and for providing unified messaging products and services.

The above objects and advantages provided hereinabove are not meant to be all inclusive of the advantages of the invention but provides the reader with a basic understanding of only some of the many objects and advantages that exist as a result of the invention. As with any computer, this invention will have virtually limitless applications.

Accordingly, many other objects and advantages of the present WiFi and WiMax technology based wireless internet invention will become apparent from the following descriptions taken in connection with the accompanying drawings, together with the foregoing are attained in the exercise of the method described wherein, by way of illustration and example, an embodiment of the present invention is fully and adequately disclosed.

Theory of Operation

In theory and concept, this WiFi and WiMax based wireless computing device functions exactly like a WiFi and WiMax compliant computer. The main advantage is the fact that the unit is using the WiFi and WiMax directly to conduct phone, video-phone, walkie talkie and messaging operations through the internet.

The Push-to-Talk or instant messaging idea is also a well known concept by the computing industry although it has never been embodied as in the present invention. This gives end users and customers the added functionality of simply pressing a button only once in order to initiate a communications sessions between devices attached to the network or any internet-works including but not limited to the internet. This push-to-talk button does not function like a standard radio frequency based walkie talkie. Rather, it is designed to be program that initiates a communications session over the internet or other network between two or more users.

Instant Messaging Freedom

Much of the functionality of the invention is based upon wireless Instant Messaging and offers the freedom to chat over a data network or the internet. Instant messaging has indeed enjoyed phenomenal success as a person-to-person communication tool; and in some instances, it has supplanted email as the preferred means of online communication. Many developers are now using this technology for application-to-person and application-to-application communication. Until recently, only a handful of service providers controlled this technology. Currently, the popular instant messaging services are communication islands based upon proprietary protocols. Implementers face a difficult decision: to support multiple protocols or lock into a single one. Regardless of the choice, the implementer must depend on a server owned by the instant messaging (IM) service provider such as America Online™. However, Open protocols offered by this invention can help developers break out of the proprietary trap. There are various advantages. Open protocols encourage development of competing implementations. They encourage widespread adoption of a common protocol, thus preventing the development of communication islands and isolationist approaches to service provisions. In many ways, open protocols made the Internet possible. In the instant messaging realm, open protocols ensure that the interoperability issues of closed systems and protocols won't stunt the growth of IM-based services. This invention also deploys Jabber standards, which is generally defined to be an open protocol for instant messaging and presence services. Jabber has the potential to break the proprietary grip on instant messaging services.

The invention implements a built-in Instant Messaging system running over a high speed computer WiFi and WiMax based wireless device based on internet protocol (ip). The high tech method is suitable for communications from anywhere in the world using the internet and the instant messenger. The most promising aspect of the invention is that it enables customers to instantly communicate in a variety of ways, to place high quality of service (QoS), low cost, Voice Over Internet Protocol (VoIP) calls via the internet or the telephone network. Instant messaging voice/text conversations can be carried on between one or more users using the concept of a wide area network.

Local/Wide Area Networking and instant messaging is well known to the computing industry and is widely used today by many internet users.

As previously stated, the device also functions as a regular wireless telephone and calls may be placed from anywhere on earth using the internet or a private voice/data network. The operation of this type of internet phone/personal communicator is depending only on the fact of HotSpot system coverage. Since the WiFi and WiMax is based on the HotSpot transmitter existence, this is the only requirement for full operation of the invention. The WiFi and WiMax technology is rapidly spreading through the world and the predication is about 80% of the world coverage by the year of 2010.

The invention serves today's busy professional and the need to instantly communicate. Many of today's computing technologies are built into one convenient package which allow customers the freedom of worldwide communications and hand held robust computing power that fits in the palm of one's hand. Some immediate benefits derived are:

(a) The use of a Personal Digital Assistant (PDA) Compatible with Palm's OS™ the Windows CE™ or Windows Pocket PC 2004™ handheld PDA operating systems, and,

(b) Cost effective Integrated Digital Telephone and Instant Messaging Services, and,

(c) The use of handheld computer for remote operations to other computers or the customers home/office based computer network, and,

(d) The use of digital voice mail transmission device which allows customers and end users the ability to transmit voice or video mail to any device in the world independent of any service provider.

The General Idea of the Invention

The general idea behind the invention is to provide customers and users with FREE or low-cost instant phone, video-phone, Fax, Email, voice messaging, advanced on-the-go WiFi and WiMax wireless computing power, wherever the WiFI and WiMax technology is provided via HotSpot coverage.

Ideally, the device should be able to connect from anywhere on earth, that is covered by HotSpot transmitter in order to communicate to anywhere in the world. The ability to instantly communicate with any other user on the Internet or the Public Switched Telephone Network is a very attractive asset and major objective of the invention.

For example, a customer located in a remote area of the world such as in the middle of the Atlantic Ocean (on a cruise for example) would still be able to connect and communicate either by voice, fax, email, video/voice mail, etc. with another telephone or computer attached to the internet, given the fact that the cruise ship is equipped with WiFi and/or WiMax HotSpot transmitter. Additionally, there has always been a need to have information at one's fingertips and this is evident by the explosion of the many Personal Digital Assistants (PDA's) and laptop computers on the market. The built-in functionality of the PDA provides customers with on-the-go power and computing applications. The use of network communications, the internet, and other established communications strategies present low cost effective and alternative communications. This invention establishes itself to be one of the most useful communications devices ever known to mankind, or the computer and telephony industry. The many novel and unobvious useful features stated herein are beneficial to individuals and companies and forms the basis for a world wide telecommunication network. With the increased, world-wide spreading of the WiFi and WiMax technology, users could use this invention almost anywhere around the world!

### Reference Numerals

| Part Number | Part Name |
|---|---|
| 1 | WiFi Technology description |
| 2 | WiMax Technology description |
| 3 | HotSpot description |

1. WiFi Technologym Description

Short for wireless fidelity and is meant to be used generically when referring of any type of 802.11 network, whether 802.11b, 802.11a, dual-band, etc. The term is promulgated by the Wi-Fi Alliance.

Any products tested and approved as “Wi-Fi Certified” (a registered trademark) by the Wi-Fi Alliance are certified as interoperable with each other, even if they are from different manufacturers. A user with a “Wi-Fi Certified” product can use any brand of access point with any other brand of client hardware that also is certified. Typically, however, any Wi-Fi product using the same radio frequency (for example, 2.4 GHz for 802.11b or 11 g, 5 GHz for 802.11a) will work with any other, even in not “WiFi Certified.”

Formerly, the term “WiFi” was used only in place of the 2.4 GHz 802.11b standard, in the same way that “Ethernet” is used in place of IEEE 802.3. The Alliance expanded the generic use of the term in an attempt to stop confusion about wireless LAN interoperability.

It's powerful. Wi-Fi networks use radio technologies called IEEE 802.11b or 802.11a to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, with an 11 Mbps (802.11b) or 54 Mbps (802.11A) data rate or with products that contain both bands (dual band), so they can provide real-world performance similar to the basic 10BaseT wired Ethernet networks used in many offices.

The 802.11 (Wi-Fi) Standards

The 802.11 standards are defined by the IEEE (Institute of Electrical and Electronic Engineers) at http://grouper.ieee.org/groups/802/11/.

| Standard | Speed | Frequency | Modulation |
|---|---|---|---|
| 802.11 | 2 Mb | 2.4 Ghz | Phase-Shift Keying |
| 802.11a | 54 Mb | 5 Ghz | Orthogonal Frequency Division |
| | | | Multiplexing |
| 802.11b | 11 Mb | 2.4 Ghz | Complementary Code Keying |
| 802.11g | 54 Mb | 2.4 Ghz | Orthogonal Frequency Division |
| | | | Multiplexing |

The 802.11 (Wi-Fi) Channels

The most common 802.11 specification, 802.11b, defines twelve channels. These channels utilize overlapping frequencies. Channels one, six, and eleven do not overlap.

2. WiMAX Technology Description

WiMAX is a standards-based technology enabling the delivery of last mile wireless broadband access as an alternative to cable and DSL. WiMAX will provide fixed, nomadic, portable and, eventually, mobile wireless broadband connectivity without the need for directs line-of-sight with a base station. In a typical cell radius deployment of three to ten kilometers, WiMAX Forum Certified™ systems can be expected to deliver capacity of up to 40 Mbps per channel, for fixed and portable access applications. This is enough bandwidth to simultaneously support hundreds of businesses with T-1 speed connectivity and thousands of residences with DSL speed connectivity. Mobile network deployments are expected to provide up to 15 Mbps of capacity within a typical cell radius deployment of up to three kilometers. It is expected that WiMAX technology will be incorporated in notebook computers and PDAs in 2006, allowing for urban areas and cities to become “MetroZones” for portable outdoor broadband wireless access.

3. HotSpot Description

HotSpots are public dial-up points create a wireless connection to the Internet. No cables that are too short, no incompatible connectors, no hassle. Just switch on and surf. Using a notebook computer with Intel® Centrino™ mobile technology or compatible (compatible WLAN card) user can easily connect to the internet. All necessary components are on board the laptop computer.

The number of hotspots is increasing all the time and everyone is joining in. Hotels, airports, stations, cafés—you can even use a wireless Internet connection in the Englischer Garten in Munich. Look out for hotspot signs, like the one above, to be sure that your WiFi-compatible WLAN notebook will work with the hotspot. This logo means that the hotspot you have chosen complies with the WiFi standard. Intel is working closely with WLAN Internet Service Providers and all certified wireless dial-up points should display this logo. Use one, and you'll have no problems getting onto the web.

Hotspot means an area covered by Wireless LAN signal through it is possible to connect to the internet. Such service is typically deployed in public places such as hotel, coffee shop, airport, city square or any public area to where is high concentration of potential users, such as business travelers, students etc.

How Does it Work?

Entering Hotspot Area

Nomadic user comes to wireless hotspot area looking for broadband Internet connection. If he already has wireless card (or it is part of his notebook) and an account for hotspot service, he can connect to wireless network. If no, he gets wireless card and arrange an account for service here.

Getting Account

User can sign for long-term hotspot service or buy appropriate pre-paid scratch card with a credit e.g. at hotel reception. So now he has got an account with username, password or other identification code.

Using Wireless Card

Many new business notebooks has already WiFi compatible wireless client adapter built in. If this feature is missing in user's notebook, he has to get one. Such wireless client adapter is available as PCMCIA card or external device for USB/Ethernet port and is usually available for buying or renting at hotspot place. Then user plugs the card in or wire the adapter to notebook and after installing drivers is ready to use it.

1. A WiFi and WiMax technology based wireless apparatus and network for establishing real time walkie-talkie, instant messaging, telephone and video-phone communications, and global unified telecommunications between wireless networks, the public switched telephone network a data network, and the internet, comprising:
(a) a built-in Instant Messenger software program capable of automatically connecting to the internet and providing a means for real time two way voice chat, text chat, and video conferencing between two or more wireless devices, and,
(b) a external Instant Messenger software program capable of being downloaded from a network or internet work computer allowing internet users to connect to a common network or internet work providing a means for real time two way voice, chat, text chat, and video conferencing between two or more devices, and,
(c) a internet email server that provides a means for receiving and delivering e-mail, voice-mail or video mail between the apparatus and users of the internet or the public switched telephone network, and,
(d) a global system for mobile communications system which uses general packet radio service, gprs protocol, and instant messaging software providing a means to wirelessly connect to a data network, a wireless network, the internet, or the public switched telephone network for voice and data communications, and,
(e) a bluetooth™ wireless technology sub system that provides a means for establishing a wireless link or wireless communications and enabling wireless links between the apparatus, office computers, mobile computers, printers, scanners, mobile phones, portable handheld devices, other bluetooth compatible devices and connectivity to the Internet, enabling freedom from wired connections, and,
(f) a microchip integrated circuit board consisting of a microprocessor, an instant messenger stay resident program, software programs programmatically linked to external function keys, mass memory, offline mass storage, an operating system, a java™ virtual machine, java user's program library, artificial intelligence voice to text, text-to-voice interpreter, and Palm OS™ or Windows CE OS™, or Windows Pocket PC 2004 operating systems for hand held computers providing a means for storing and using the software programs of the apparatus, and,
(g) a Intel™ Pentium™ 4 Mobile processor-M system capable of supporting high speed handheld wireless mobile communications providing a means for high speed data transfers and superior multimedia communications, and
(h) a solar recharging sub system with embedded solar panel that provides a means for automatically recharging the batteries with the use of a light source or power from the sun, and,
(i) a WWW-OS operating system that provides a means to launch, control, and monitor the operations of the said apparatus, built-in programs, user programs, and communication processes, and,
(j) a Microsoft Pocket PC 2004™ built-in operating system which can be loaded on demand or after the start of a new power on self test session which provides a means of diverse mobile computing functionality of the apparatus, and,
(k) a built-in Instant Messenger software program capable of automatically connecting to the internet and providing a means for two way voice chat, text chat, and video communication between two or more devices, and,
(m) a push-to-talk-worldwide external function button capable of executing a built-in software program stored on the microchip integrated circuit board providing a means for initiating and establishing instant communications sessions between two or more telephones, computers, or devices connected via any data network, wireless network, the internet, or the public switched telephone network, and,
(n) a send voice mail external function button capable of executing a built-in software program stored on the microchip integrated circuit board providing a means for instantly transmitting prerecorded digital voice messages to any telephone, computer, or device connected via any data network, wireless network, the internet, or the public switched telephone network, and,
(o) a send video mail external function button capable of instantly executing a built-in software program stored on the microchip integrated circuit board and means for transmitting real time or prerecorded digital video messages to any telephone or computer connected via any data network, wireless network, the internet or the public switched telephone network, and,
(p) a record memo external function button capable of instantly executing a built-in software program stored on the microchip integrated circuit board providing a means for efficiently composing storing, and indexing digital voice recording or video recording memo allowing for the efficient storage, access, and retrieval of digital data, and,
(q) a send/receive fax external function button capable of instantly executing a built-in software program stored on the microchip integrated circuit board providing a means for expeditiously composing and transmitting internet protocol based facsimile messages from the said apparatus to any fax machine, computer, or compatible device connected via any data network, a wireless network, the internet or the public switched telephone network, and,
(r) a send email external function button capable of executing a built-in software program stored on the microchip integrated circuit board providing a means for instantly composing voice-to-text or keyboard generated messages for transmitting email messages to any email address, telephone, computer, or internet device via any data network, wireless network, the public switched telephone network, or the internet, and,
(s) a PDA external function button capable of executing a built-in software program stored on the microchip integrated circuit board providing a means for launching and communicating with the built-in personal digital assistant handheld software applications that provides computing and information storage and retrieval capabilities for personal or business use or for keeping schedule calendars and address book information handy, and,
(t) a stylus pen which provides a convenient object or means of making selections and operations of the personal digital assistant, and,
(u) a stylus pen compartment which provides a means of storage for the stylus pen, and,
(v) a TALK-INTERNET external function button capable of executing a built-in software program stored on the microchip integrated circuit board providing a means for instantly initiating computer to computer voice calls or voice over internet protocol telephone calls to any telephone, computer, or internet device via any data network, a wireless network, the public switched telephone network, or the internet, and,
(w) a END external function button capable of terminating voice or voice over internet protocol telephone calls, and,
(x) a ENTER external function button providing a means for obtaining terminal or keyboard input from a human user to be sent to the apparatus for subsequent processing, and,
(y) a MENU external function button capable of display internal software menus providing a means for the selection of generic software programs, and computer applications, and,
(z) a external dialing pad providing a means for dialing or entering a telephone number and the entry of numeric and alphanumeric data, and,
(aa) a external revolving built-in web camera capable of a minimum resolution of 320.times.240 pixels providing a means for real time videoconference or for producing digital still images, and,
(bb) a external snap button which provides a means for taking digital pictures or recording digital real time movies, and,
(cc) a reflective touch sensitive display screen with a minimum of 4096 color Resolution and 240.times.320 graphic display system providing a means for displaying real time video communications, internet content, and general data and device information, and,
(dd) a navigational key set having four distinct arrow keys which point in the up, down, left and right directions providing an alternate means for a user or operator of the apparatus to make menu or screen selections of items displayed on the touch sensitive display screen, and,
(ee) a revolving mouse ball which provides a means for a user or operator of the apparatus to select items displayed on a screen from software applications, and,
(ff) a mini listening speaker providing a means for hearing telephone or chat conversations, and,
(gg) a multimedia loud speaker and microphone which provides a means of hearing hands free telephone conversation, and a general multimedia speaker and microphone for multimedia application, and,
(hh) a flip cover case which provides a means of protective covering for the apparatus and for hearing telephone or chat conversation with the built-in mini listening speaker, and,
(ii) a universal serial bus port having both USB 1.1 and USB 2.0 compatibility which provides a means and a solution for any personal computer user to exchange data with the apparatus and other USB compatible devices, and,
(jj) a infrared port capable of using bluetooth™ or compatible wireless communications which provides a means for wireless upload and download of data between the apparatus and a personal computer and which provides a wireless link to compatible devices for wireless connectivity purposes or to wireless exchange data, and,
(kk) a WAP or wireless access protocol system which provides a means to allow users to access information from a data network, a wireless network, or the internet, and,
(mm) a short message service which provides a means for the said apparatus to send text messages to other cell phones, and,
(nn) a simple mail transfer protocol that provides a standard means for sending email messages via the internet, and,
(oo) a built-in I-mode™ system of communications which interacts with the instant messenger system providing an alternatives means for mobile internet access system or service to users in Japan, and all countries of the world, and,
(pp) a belt clip attachment which is affixed on the rear of the apparatus that provides a means of attaching the apparatus to a waist belt and,
(qq) a battery compartment which provides a means of housing rechargeable batteries used to power the apparatus, and,
(rr) a voice-to-text processor which translates voice input to text output and providing a means for composing email messages, and chat messages without the need for a keyboard and,
(tt) a desktop communications program which executes on a personal computer providing a means for intercommunications, synchronization, and data exchange between a personal computer and the apparatus, and,
(uu) a java™ programs library that provides a means for storage of java based computer programs, and,
(vv) a java™ virtual machine that provides a means for the execution of java enabled or java compiled programs to be run in real-time, and,
(ww) a built-in micro-browser the provides a means to browse web pages and content on the internet or the world wide web, and
(xx) a power source connection port which allows for the connections of external power sources or data sources to be connected as a means for providing power or data transfers, and,
(yy) a portable keyboard which folds and unfolds into a full size computer keyboard providing a means for convenient data entry, and,
(zz) a physical housing which provides a convenient means of housing the integrated microchip circuit board and the parts of the apparatus, and,
(aaa) a bluetooth™ stereo wireless headset which connects directly to the apparatus via a wireless connection which provides means of monitoring voice communications and for executing voice commands to the apparatus, and,
(bbb) a voice command library capable of executing voice commands to control operations, and,
(ccc) a registered user data base for storing registered users of the voice over internet protocol network, and,
(ddd) a security access control matrix program for controlling authorized access to the data or network server, and,
(eee) a voice over internet protocol fax gateway system for forwarding fax messages to any fax machine or computer, and, a ac/dc 120 v/220 v power charger (32A) for an alternative charging power source, and,
(fff) a 12 Volt DC power adapter (33) for an alternative charging power source, and,
(ggg) a hotsync button (32B) used to synchronize data of the apparatus with a Personal computer, and,
(hhh) a java™ based virtual push-to-talk-worldwide program which executes on the voice over internet protocol server capable or executing computer instructions over the internet or any data network that allows internet uses to intercommunicate with the apparatus, telephones, and any computer attached to the network.

2. The invention of claim 1 further including a high speed resilient, robust computer distributed networked based system, virtual wireless device, hardware, software, and voice over internet protocol based network capable of eliminating delay, echo, accumulation delay, jitters, and lost packets that affect voice quality capable for superior quality of service (Qos) for voice quality over a wireless network, based on WiFi and WiMax Technology further comprising:
(a) a internet based web server and ip managed network for providing voice and text based instant messenger communications services, enhanced Quality of Services, and,
(b) a server based virtual communications interface software program embodied with a computer based representation of a standard telephone dial pad, a virtual screen, a virtual push-to-talk-worldwide button for initiating instant messaging, and voice over internet protocol sessions, and,
(c) a server based universal instant messenger software program for allowing end-users and internet computer users and other cellular telephone users to instantly communicate via voice, text chat, and video conferencing in real time using voice, text and video messaging, and,
(d) a computer based virtual PUSH-TO-TALK-WORLDWIDE function protocol button programmed in Java, flash, or any suitable programming language which when depressed has the capability of initiating real time bisynchronous voice over internet protocol calls between internet computers, any wireless network, and the public switched telephone network providing for material cost reduction involved in long distance telephone, facsimile, and data communications, and,
(e) a computer based virtual SEND VOICE MAIL button which when selected or clicked with a computer mouse is capable of providing digital recordings that can be stored, or forwarded to any other apparatus, telephone, or computer attached to the internet, and,
(f) a computer based virtual SEND FAX MESSAGE button which when selected or clicked with a computer mouse will allow the attachment of data files that can be sent to any apparatus, fax machine or computer attached to the internet, and,
(g) a computer based virtual SEND EMAIL button which when selected or clicked with a computer mouse will launch or execute email client software instructions to allow the transmission of email messages from the server to any email address, telephone, or computer attached to the internet, and,
(h) a computer based virtual SEND VIDEO MAIL button which when selected or clicked with a computer mouse will allow the transmission of pre-recorded video messages from the server to any email address, telephone, or computer attached to the internet, and,
(i) a computer based virtual MESSAGE MEMO button which when selected or clicked with a navigational computer mouse will function with a computer microphone and will allows the composition of digital memos that can be subsequently stored, played, or forwarded to any telephone, or computer attached to the internet, and,
(j) a computer based virtual TALK-INTERNET button which functions with the instant messenger system and which when selected or clicked with a navigational computer mouse will allows for Voice Over Internet Protocol or VoIP calls to be placed to any telephone or computer attached to the internet, and,
(k) a computer based virtual MENU button which is used to stored computer programs and data on the server and wireless apparatus, and,
(l) a computer based virtual ON/OFF button for enabling and disabling PUSH-TO-TALK-WORLDWIDE operations, voice over ip operations, and other virtual function buttons, system programs and applications of the virtual apparatus, and,
(m) a computer based interface software program that allows login, entry of user name and password for user identification, and authentication providing a means for controlling access to software programs and communications services stored on the server or data network.

3. The instant Messenger software program of claim 1 that is capable of being executed on a Java™ based software platform or any hardware platform capable of running java™ programs further comprising:
(a) a software program which provides a means to automatically interface or connect to the America Online™ instant messenger or American Online™ computer network, and,
(b) a software program which provides a means to automatically interface or connect to the Yahoo™ instant messenger or Yahoo™ computer network, and,
(c) a software module for inviting non-users to download and install the instant messenger software providing a means for other users to intercommunicate using other network devices, computers, cellular telephones, and,
(d) A Jabber XML-based data model and protocol for instant messaging service providing a protocol and means for easy software development and breaking out of proprietary instant messaging services, and,
(e) a software program which automatically connects to a internet based voice over internet protocol server or gateway providing a means of indicating the online status of the apparatus, and,
(f) a software program which indicates the online status for broadcasting the said status to other computers or devices on the same network or internet-work using the said instant messenger software, and,
(g) a software program which allows end-users of the apparatus to change the status to offline or any other state, or to disable the instant messenger features, and,
(h) a software program which functions in conjunction with the instant messenger allowing end-users of the apparatus to enable or disable operations of the built-in web camera, and,
(i) a software program for storing and accessing the details of an instant messaging contact record, and,
(j) a software program that allows the additions, deletions, and modifications of instant messaging user names in any category providing a means for maintenance of the instant messenger buddy list, and,
(k) a software program having the capability of transmitting short text messages and interfacing with the voice-to-text processor providing a means to send short text messages using a human voice, and,
(l) a software program that function in conjunction with the wireless apparatus and network having the capability of executing voice over ip services to any computer, telephone, or device connected to a wireless network, the public telephone network, or the internet, and,
(m) a software program that functions in conjunctions with the wireless apparatus and push-to-talk-worldwide button that is capable of connecting voice over internet protocol sessions between two or more computers, telephone, or internet devices which use the same instant messenger and internet work.

4. The Menu function key of claim 1 that is linked to internal software modules capable of displaying a list of commands, internal programs, and executable software programs, comprising:
(a) a hot-sync data transfer software program providing a means for synchronizing data between a personal computer and the apparatus of claim 1, and,
(b) a loader program capable of loading into memory the Palm OS™ operating system, Windows CE™ operating System, or the Windows Pocket PC 2004 operating system, and,
(c) a loader program capable of loading into memory any terminal emulation or remote control program providing a means for access to remote computer systems, and,
(d) a software based MP3 player for playing mp3 sound files, and,
(e) a send page function capable of transmitting paging messages to any pager or device connected via the internet or the public switched telephone network, and,
(f) A re-boot or restart program capable for allowing a hardware reset of the apparatus, and,
(g) A software program used to launch the internal micro-browser providing a means for browsing the world wide web, and,
(h) A registration program that provides a means of registering the apparatus to the data or wireless network, and,
(i) A loader system program that can be used to launch or load any other computer program residing in the apparatus, and,
(j) A WWW-T terminal emulation software program for connecting to remote computers, and,
(k) a software program for loading any Java based application programs, and,
(l) a software program or webpage link for downloading the instant messenger from a network or web-server, and,
(m) a software program which functions in conjunction with the WWW-OS operating system that allows for the storing, modification, and accessing, of electronic addresses and contact information, and,
(n) a digital voice recorder software program which functions in conjunction with the WWW-OS operating system for creating and storing digital voice recordings, and,
(q) a software program which functions in conjunction with the WWW-OS operating system that allows any java software program to be uploaded to the java program library.

5. The wireless apparatus of claim 1 which is further capable of identifying itself on any data or wireless network, or the internet, as a server or standalone internet protocol based computer providing a means for continuous communications in the event the main internet gateway server becomes unavailable due to hardware failures and software failures.

6. The wireless apparatus described in claim 1 above which has the capability of assigning itself an internet protocol (ip) address or which may be assigned an internet protocol address by an internet based server and which is further capable of being addressed by any other user, computer, or ip based device on a data network, wireless network, or the internet, whereby the apparatus is able to function as an internet voice over ip server able to stand alone without the use of a gateway server, enabling the apparatus to function as a valid voice over ip device on a data network, a wireless network, or the internet.

7. The wireless apparatus and network of claim 1 capable of accessing third party internet protocol (IP) telephony gateways or internet fax gateways, whereby the apparatus is able to connect to third party networks, comprising:
(a) software modules capable of interfacing with third party equipment and a means for executing any third party voice over internet protocol software used in telephony applications, and,
(b) software modules capable of interfacing with third party equipment and a means for executing any third party software to connect to any data or wireless network, and,
(c) software modules capable of executing or interfacing with the America Online™ instant messenger system, and,
(d) software modules capable executing or interfacing with the Yahoo™ instant messenger system, and,
(e) software modules capable of interfacing with third party equipment and a means for using voice over internet protocol and ip based fax software for transmitting voice, facsimiles, and email messages to any telephone, computer, or fax machine in the world.

8. The network of claim 1 configured as Cisco™ AVVID Network Architecture™ or equivalent internet based Voice over Internet Protocol (VoIP) server and network system of servers capable of providing high Quality Of Service (Qos) voice calls, video chat, internet protocol facsimile calls, and managing user and communication sessions between the public switched telephone network, any data network, a wireless network, or the internet.

9. Multifunctional WiFi and WiMax based Walkie Talkie, a high speed wireless IP based computer/instant messenger, Personal Digital Assistant, coupled with a robust, resilient VoIP data network server, and wireless network deploying multiple wireless protocols and personal communication services, including GPRS, WAP, Bluetooth, CDMA, PCS, Voice Over IP Communications, and I-mode service, whereby quality of service (QoS) VoIP and Instant Messenger services are used over a GPRS, or WAP wireless connection allowing Internet users, land line telephones, and cellular/satellite telephone users to videoconference, chat, talk, and intercommunicate worldwide via the internet, comprising:
(a) a high speed Intel Pentium 4 Mobile-M or equivalent microprocessor platform equipped with WiFi and WiMax technology which deploy data prefetch logic, and rapid execution engine that guarantee continuous power to the computer for processing the most data-intensive and graphic rich applications, and,
(b) a cellular telephone shaped physical water proof housing comprised of solar conducive material for charging batteries, and a face plate, which functions as a protective cover and to contain special function buttons used by the wireless computer/instant messenger, providing a protective housing for function buttons, circuit boards, and the Intel Pentium 4 Mobile-M or equivalent microprocessor, and,
(c) a VoIP gateway server that functions in conjunction with the wireless computer instant messaging computer for establishing quality of voice over internet protocol services, low cost, real time global communications, and videoconferencing over any wireless network to the public switched telephone network via a data network, VoIP gateway server, and the internet, and,
(d) a internal stay resident Instant Messenger software system that executes within the random access mass memory of the computer/instant messenger, through and with the VoIP gateway server for establishing a high speed wireless internet connection to a VoIP gateway server allowing real time wireless VoIP voice messaging, video conferencing, terminal online and presence functions, and text chatting, over a wireless network, via the internet, and,
(e). a global system for mobile communications (gsm) wireless telephone network that uses group packet radio service protocol allowing for a dual connection to a wireless gsm network and the VoIP internet gateway server, and,
(f) a random access mass memory for processing and executing computer programs and software instructions, and,
(g) a offline mass storage for storing digital data, voice data, and data in various known formats, and,
(h) a java™ enabled pcs/gsm digital cell phone logic controller microchip for processing java based computer programs within the wireless computer/instant messenger, and,
a) a java™ based user program library for storing java based computer programs within the wireless computer/instant messenger, and,
(k) a java™ virtual machine which operates within the wireless computer/instant messenger for viewing java™ based web pages, and applications designed with the java programming language, and,
(l) a send/receive fax function button located on the face plate of the wireless computer/instant messenger, and,
(m) a send/receive fax software program that functions in conjunction with the send/receive fax function button and operating system that allow for the transmission and reception of data files, attachments, and facsimile messages through the internet gateway server to any fax machine, or computer attached to the internet, and,
(n) a voice command library that functions in conjunction with the operating system used to store and process voice commands for executing specific functions within the wireless computer/instant messenger, and,
(o) a mini web camera positioned on the face plate of the wireless computer/instant messenger for videoconferencing, recording real time video movies, and recording still digital pictures or digital images, and,
(p) a built-in highly sensitive multi-media loudspeaker/microphone (22) for hearing audio output and recording digital voice recordings, and,
(q) a built-in mini speaker for hearing telephone conversations and playing audio files stored within the wireless computer/instant messenger, and,
(r) a send/receive video mail function button located on the face plate of the wireless computer/instant messenger, and,
(s) a send/receive video mail software program that functions in conjunction with the send/receive video mail function button, web camera, and operating system that allows for the transmission and reception of real time video messages, or digital pictures, to any telephone, internet computer, or internet based communications device able to receive digitally produced data, and,
(t) a send/receive voice mail function button located on the face plate of the wireless computer/instant messenger, and,
(u) a send/receive voice mail software program that functions in conjunction with the send/receive voice mail function button, highly sensitive microphone, and operating system that allows for the recording of digitally produced voice recordings, and,
(v) a simple mail transfer protocol system that functions in conjunction with the operating system, and the VoIP gateway server, for transmission and reception of email messages via the internet, and,
(w) a send/receive email function button located on the face plate of the computer/instant messenger, and,
(x) a send/receive email software program that functions in conjunction with the simple mail transfer protocol system, the operating system, and the VoIP server for transmission and reception of email messages over the internet, and,
(y) a record message memo function button located on the face plate of the wireless computer/instant messenger, and,
(z) a on/off function button for applying power and tuning off the wireless computer/instant messenger, and,
(aa) a built-in I-mode™ system of communications which functions with the operating system, and instant messenger that provides alternatives for mobile internet access system, and,
(bb) a menu function button for displaying a menu of computer software applications within the wireless computer/instant messenger, and,
(cc) a revolving mouse ball positioned on the face of the wireless computer/instant messenger for making menu selections or executing programs within the wireless computer/instant messenger, and,
(dd) a record message memo software program that functions in conjunction with the operating system within the computer/instant messenger for recording digital voice recordings for storage within the wireless computer/instant messenger, and,
(ee) a push-to-talk function button located on face plate of the wireless computer/instant messenger, and,
(ff) a push-to-talk software program that functions in conjunction with the push-to-talk function button, the instant messenger, the operating system, web camera, a wireless network, and the VoIP server, for initiating video conferencing and wireless voice over internet protocol communications between two or more internet users allowing global communications, and,
(gg) a talk-internet function button located on the face plate of computer instant messenger, and,
(hh) a talk-internet software program that functions in conjunction with the talk-internet function button, the operating system, web camera, and the VoIP server for initiating wireless voice over internet protocol telephone calls to any telephone or between interconnected internet computers, and,
(ii) a PDA function button located on the face plate of the computer instant messenger, and,
(jj) a PDA software program that functions in conjunction with the PDA function button, and operating system capable of launching or executing any personal digital assistant software, and,
(kk) a built-in artificial intelligence voice to text interpreter which functions in conjunction with the operating system for converting human voice to text, and,
(mm) a high definition television screen which uses MPEG-2 and other compressed digital formats for viewing visual data on the computer/instant messenger, and,
(oo) a security access control matrix program for controlling access to the VoIP gateway server, and,
(pp) a registered user data base for registering and storing registered users of the VoIP gateway server, and,
(qq) a java applet instant messenger program which functions in conjunction with the VoIP gateway server, an internet service provider, and the internet, for allowing instant messaging between internet users, internet protocol based devices, the computer/instant messenger, a wireless network, the public switched telephone network, and internet, and,
(rr) a infrared port capable of using bluetooth wireless communication for allowing bluetooth wireless communications and data exchanges to other enabled bluetooth devices including computers, personal digital assistants, printers, and scanners, and,
(ss) a bluetooth intelligent wireless voice command stereo headset for hearing audio signals, and transmitting wireless voice commands to the wireless computer/instant messenger providing a means for remote operations, remote control, and hands free telephone and chat conversations and,
(tt) a navigational key-set pointing in all four directions located on the face of the computer/instant messenger for navigating web pages and selecting information displayed within the video screen of the computer/instant messenger, and,
(uu) a onscreen keyboard for data entry of information to the wireless computer/instant messenger, and,
(vv) a internal mini web browser that functions in conjunction with the operating system for surfing the web, and,
(ww) a standard telephone dialing pad having standard telephone dialing keys for entering alphanumeric data and initiating standard wireless telephone calls, and,
(xx) a universal serial bus port located on the side of the computer/instant messenger for USB connectivity with any compatible usb device, and,
(yy) a ac/dc 120 v/220 v power charger providing for electrical charging of the computer/instant messenger, and,
(zz) a 12 volt dc power adapter (33) for charging or applying power to the computer/instant messenger, and,
(aaa) a power source connection data port allowing for an external power source and data to be used with external
(bbb) a built-in self recharging solar sub-system that provide continuous recharging to the wireless computer/instant messenger with direct sun light or from any artificial light source, and,
(ddd) a foldable keyboard (90) that can be mounted on the data port (23) providing a full size keyboard for data entry into the wireless computer/instant messenger, and,
(eee) a virtual world wide walkie talkie server interface program that provides VoIP network interfaces between the internet, a any wireless network, and the public switched telephone network having quality of voice (QoS) voice over internet protocol services, telephony application programmable interface (TAPI) standards, and java telephony application programmable interfaces, (JTAPI).

10. The WiFi and WiMax technology based wireless apparatus of claim 1 capable of accessing the internet protocol (IP) telephony gateways or internet fax gateways, comprising:
(a) a built-in internet link that is controlled by software and,
(b) a software that is establishing the internet connection via link to the internet protocol (IP) telephony gateway.
